(19) United States
(12) Patent Application Publication
(10) Pub. No.: US 2026/0202296 A1
(43) Pub. Date: Jul. 16, 2026

(54) THERMAL SHOCK SYSTEM

(71) Applicant: Tesla, Inc., Austin, TX (US)

(72) Inventors: Nosherwan Adil, Mountain View, CA (US); Christopher Stracuzzi, Monterey, CA (US); Adrian Bermudez, Stockton, CA (US)

(21) Appl. No.: 19/018,855

(22) Filed: Jan. 13, 2025

(51) Int. Cl. G01N 3/60

(52) U.S. Cl. CPC G01N 3/60; G01N 2203/0057; G01N 2203/0226; G01N 2203/0228

(57) ABSTRACT

A thermal shock system for testing components can include a cold fluid supply circuit configured to deliver a cold fluid and a hot fluid supply circuit configured to deliver a hot fluid. The system can feature a heat exchanger fluidly connected to both the cold and hot fluid supply circuits. A valve manifold, fluidly coupled to the cold and hot fluid supply circuits, can direct the fluids to a thermal shock circuit. The thermal shock circuit, designed to receive a component for thermal shock testing, can include a tertiary fluid that can be selectively thermally coupled with the cold or hot fluid via the heat exchanger based on the configuration of the valve manifold.

### TECHNICAL FIELD

The examples described herein generally relate to systems for thermal shock testing, which can include simultaneous thermal shock testing of one or more components.

### BACKGROUND

Thermal shock is a phenomenon characterized by a rapid change in temperature that results in a transient mechanical load on an object. The load can be caused by the differential expansion of different object parts due to the temperature change. This differential expansion can be understood in terms of strain rather than stress. When the strain exceeds the tensile strength of the material, cracks can form and eventually lead to structural failure. Thermal shock tests can determine the weakest link in part or product design. It is also an accelerated test for the reliability expectations of a product.

### BRIEF DESCRIPTION OF THE DRAWINGS

Various examples are illustrated in the figures of the accompanying drawings. Such examples are demonstrative and not intended to be exhaustive or exclusive examples of the present subject matter.

FIG. 1 illustrates a schematic diagram of an example of a thermal shock system, according to some examples.

FIG. 2 illustrates a schematic diagram of an example of a thermal shock system operating in a first mode, according to some examples.

FIG. 3 illustrates a schematic diagram of an example of a thermal shock system operating in a second mode, according to some examples.

FIG. 4 illustrates a schematic diagram of an example of a thermal shock system operating in a switching mode, according to some examples.

FIG. 5 illustrates a schematic diagram of an example of a calibration cycle for a thermal shock circuit, according to some examples.

FIG. 6 illustrates a perspective view of an example of a thermal shock circuit, according to some examples.

FIG. 7 illustrates a perspective view of an example of a chamber, according to some examples.

FIG. 8 illustrates an example of a graphical user interface, according to some examples.

FIG. 9 illustrates a block diagram illustrating an example of a machine upon which one or more examples can be implemented, according to some examples.

FIG. 10 illustrates a block diagram of an example method of manufacturing a thermal shock system, according to some examples.

FIG. 11 illustrates a block diagram of an example method of operating a thermal shock system, according to some examples.

### DETAILED DESCRIPTION

Thermal shock testing can be an important process used to evaluate the reliability and durability of components in various industries, including but not limited to automotive, battery, and data center applications. Conventional thermal shock systems, however, can face several limitations that can impact their effectiveness and efficiency.

One problem with existing systems can be their inability to independently control multiple test components simultaneously. Typically, these systems can use a single coolant supply connected directly to the device under test, making it challenging to manage different flow rates and pressure requirements for multiple parts. This limitation can often result in inefficient testing processes and potential inaccuracies in test results.

Another issue with current systems can be the risk of contamination and damage to the main cooling equipment. When testing components that may contain debris or particulates, such as 3D-printed parts with metal or plastic powder residue, the primary coolant loop can become contaminated. This contamination can lead to clogged filters, damage to refrigeration equipment, and increased maintenance requirements.

Additionally, existing thermal shock systems can be prone to single points of failure. In setups where multiple tests are completed, a leak in one component can cause the entire system to drain, potentially damaging other test subjects and leading to significant downtime.

The thermal shock system described in the present disclosure can address these limitations and offer several key benefits. The system can utilize intermediate heat exchangers and separate device under test (DUT) loops, allowing for independent control of flow rate and pressure for each test component. This feature can enable simultaneous testing of parts with varying requirements, improving overall efficiency and accuracy. By separating a main chiller loop from the DUT loops through intermediate heat exchangers, the system can limit contamination of the primary coolant supply. This design can reduce maintenance needs and protect expensive cooling equipment from damage. The system's architecture can help to eliminate single points of failure by isolating individual test chambers. A leak or failure in one component may not affect the testing of other parts, ensuring continuous operation and minimizing downtime. The separation of loops can allow for the use of different coolants in various parts of the system, accommodating specific requirements for different programs or applications. The system can incorporate advanced control features, including a graphical user interface for flow control, data logging, and process parameter display. It can also include calibration cycles to optimize pump settings across a range of coolant temperatures. The system can operate within a coolant temperature range of −40° C. to 85° C., making it suitable for a broad spectrum of testing scenarios. By addressing these key issues and incorporating advanced features, the present thermal shock system can offer a more versatile, reliable, and efficient solution for thermal shock testing across various industries and applications.

In examples, a thermal shock system for testing components can include a cold fluid supply circuit configured to deliver a cold fluid and a hot fluid supply circuit configured to deliver a hot fluid. A heat exchanger can be fluidly connected to the cold fluid supply circuit and the hot fluid supply circuit. A valve manifold can be fluidly coupled to the cold fluid supply circuit and the hot fluid supply circuit. A thermal shock circuit can be coupled to the valve manifold. The thermal shock circuit can be configured to receive a component for thermal shock testing. The thermal shock circuit can include a tertiary fluid that can be selectively thermally coupled, via the heat exchanger, to the cold fluid or the hot fluid based at least in part on a configuration of the valve manifold. The thermal shock circuit can be configured to expose the component to a temperature based at least in part on the valve manifold being in a configuration to thermally couple the tertiary fluid with the cold fluid. The thermal shock circuit can be configured to expose the component to a second temperature based at least in part on the valve manifold being in a second configuration to thermally couple the tertiary fluid with the hot fluid.

In examples, a thermal shock system for testing two or more components in different chambers can include a cold fluid supply circuit to deliver a cold fluid, a hot fluid supply circuit to deliver a hot fluid, and a plurality of test chambers. Each test chamber of the plurality of test chambers can include a heat exchanger with a primary side and a secondary side. A fluid distribution network can be configured to selectively route the cold fluid and the hot fluid to the primary side of the heat exchangers. The thermal shock system can also include a plurality of device under test circuits. Each device under test circuit of the plurality of device under test circuits can be connected to the secondary side of the heat exchanger and configured to circulate fluid to a component within the respective test chamber of the plurality of test chambers. A control system can be configured to: control the fluid distribution network to alternatively expose the plurality of device under test circuits to the cold fluid and the hot fluid via the heat exchangers; and independently control fluid flow in each device under test circuit of the plurality of device under test circuits.

In examples, a method of operating a thermal shock system can include directing a cold fluid from a cold fluid supply circuit and a hot fluid from a hot fluid supply circuit to a valve manifold. The method can also include alternately directing, via the valve manifold: the hot fluid to a first thermal shock circuit to expose a first component to a first temperature and the cold fluid to the first thermal shock circuit to expose the first component to a second temperature.

The above discussion is intended to provide an overview of the subject matter of the present patent application. It is not intended to provide an exclusive or exhaustive explanation of the invention. The description below is included to provide further information about the present patent application.

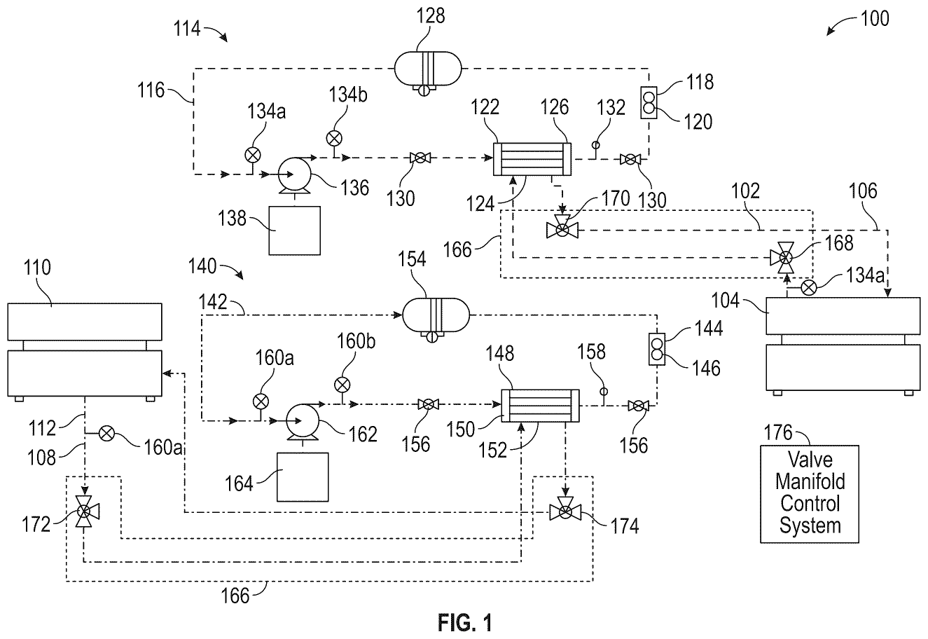

FIG. 1 illustrates a schematic diagram of an example of a thermal shock system 100, according to some examples. The thermal shock system 100 can be configured to alternate at least one device under a testing circuit between determined hot and cold temperatures. Each device under test circuit can be isolated from other device under testing circuits. The thermal shock system 100 can simultaneously complete thermal shock testing on two or more components (e.g., a first component 120 and a second component 146) received within chambers (e.g., first chamber 118 and second chamber 144, respectively). To complete the testing, the thermal shock system 100 can expose the components to a hot fluid 106 and a cold fluid 112 alternatively at a set interval, temperature, and pressure. The thermal shock system 100 can separately control the temperature and pressure supplied to each of the first chamber 118 and the second chamber 144 such that each component can be run through a specified thermal shock test based on the design requirements. The thermal shock system 100 can include a hot fluid supply circuit 102, a hot fluid source 104, a cold fluid supply circuit 108, a cold fluid source 110, a first thermal shock circuit 114, a second thermal shock circuit 140, and a valve manifold 166.

The hot fluid supply circuit 102 can deliver or provide a hot fluid 106 (e.g., glycol, glysantin G48, de-ionized water, any other cooling fluid, or the like) to the thermal shock system 100. The hot fluid supply circuit 102 can include a hot fluid source 104 (e.g., a boiler, a heater, a furnace, other heating means, or the like) to heat the hot fluid 106 to a set threshold temperature. The hot fluid supply circuit 102 can include one or more pumps to deliver the hot fluid 106 to at least one of the first thermal shock circuit 114 or the second thermal shock circuit 140 at a consistent temperature and pressure.

The cold fluid supply circuit 108 can deliver or provide a cold fluid 112 (e.g., glycol, glysantin G48, de-ionized water, any other cooling fluid, or the like) to the thermal shock system 100. The cold fluid supply circuit 108 can include a cold fluid source 110 (e.g., a chiller, air conditioner, cooling tower, other cooling means, or the like) to cool the cold fluid 112 to a set threshold temperature. The cold fluid supply circuit 108 can include one or more pumps to deliver the cold fluid 112 to at least one of the first thermal shock circuit 114 or the second thermal shock circuit 140 at a consistent temperature and pressure.

The first thermal shock circuit 114 can receive the first component 120 within the first chamber 118 for thermal shock testing. The first thermal shock circuit 114 can provide a first fluid 116 (e.g., glycol, glysantin G48, de-ionized water, any other cooling fluid, or the like) to the first chamber 118 to control the temperature of the first chamber 118 to a set threshold separate from the thresholds of the hot fluid supply circuit 102 and the cold fluid supply circuit 108. The first thermal shock circuit 114 can include the first chamber 118, a first heat exchanger 122, a reservoir 128, a pump 136, one or more thermal sensors 132, and one or more pressure sensors 134 (e.g., a first pressure sensor 134a, a second pressure sensor 134b, and a nth pressure sensor 132n).

The first heat exchanger 122 can be fluidly connected to the hot fluid supply circuit 102, the cold fluid supply circuit 108, and the first thermal shock circuit 114. The first heat exchanger 122 can transfer thermal energy from the hot fluid 106 or the cold fluid 112 to the first fluid 116 of the first thermal shock circuit 114. The first heat exchanger 122 can include a shell and tube heat exchanger including a shell side 124 and a tube side 126. The shell side 124 can include tubing routed through an outer shell of the heat exchanger 122. The tube side 126 can include a series of tubes extending within the outer shell of the heat exchanger 122. In examples, the shell side 124 and the tube side 126 can be fluidly isolated and thermally coupled so that fluid within one of the shell side 124 or the tube side 126 can heat or cool fluid in the other of the shell side 124 or the tube side 126.

The first heat exchanger 122 can alternatively receive the hot fluid 106 or the cold fluid 112 on the shell side 124 of the first heat exchanger 122 and transmit thermal energy to the first fluid 116 on the tube side 126. In examples, the first heat exchanger 122 can include other forms of heat exchangers (e.g., a plate heat exchanger, a finned tube heat exchanger, a double pipe heat exchanger, a scraped surface heat exchanger, or the like). The first thermal shock circuit 114 can also include multiple of the first heat exchangers 122 to further increase thermal heat transfer between the hot fluid 106, the cold fluid 112, and first fluid 116 of the first thermal shock circuit 114. For example, the first thermal shock circuit 114 can include a first of the first heat exchanger 122 fluidly connected between the hot fluid 106 and the first fluid 116 of the first thermal shock circuit 114 and a second of the first heat exchanger 122 fluidly connected between the cold fluid 112 and the first fluid 116 of the first thermal shock circuit 114.

The reservoir 128 can receive, store, and maintain a temperature of the first fluid 116 within the first thermal shock circuit 114. As shown in the example of the thermal shock system 100 shown in FIG. 1, the reservoir 128 can be fluidly connected to the first thermal shock circuit 114 between the first chamber 118 and the pump 136. In examples, the reservoir 128 can be fluidly connected to the first thermal shock circuit 114 between the pump 136 and the first heat exchanger 122, between the first heat exchanger 122 and the first chamber 118, between the hot fluid supply circuit 102 and the cold fluid supply circuit 108 and the first thermal shock circuit 114, or as a separate bypass that is used only when liquid needs to be added or removed from the first thermal shock circuit 114. As the reservoir 128 can maintain the temperature of the fluid within the first thermal shock circuit 114, the reservoir 128 can include insulation to help limit thermal transfer from the first fluid 116 to the environment surrounding the reservoir 128.

The valve 130 can be operable to control (e.g., permit or stop) flow to the first chamber 118. The valve 130 can be actuated to stop flow into the first chamber 118 such that the first chamber 118 can be emptied to change, engage with, or remove the first component 120. The valve 130 can also be configured to open to permit the first fluid 116 to flow into the first chamber 118. In examples, the valve 130 can be modular. The modular version of the valve 130 can be modulated to increase or decrease flow into the first chamber 118.

The pump 136 can pressurize the first fluid 116 within the first thermal shock circuit 114. The pump 136 can include a pump controller 138, which can be a controller such as a single or multi-board computer, a direct digital controller (DDC), a programable logic controller (PLC), printed circuit board (PCB), or the like, configured to control a discharge pressure and pumping rate (e.g., flow rate) of the pump 136 based on input form one or more components of the first thermal shock circuit 114. The pump 136 and the pump controller 138 can be together operable to control the pressure and flow rate of the first fluid 116 within the first thermal shock circuit 114. In examples, the pump 136 can include a centrifugal pump (e.g., an end-suction pump, vertical in-line pump, split-case pump, vertical multi-stage pump, or the like), rotodynamic pump, reciprocating pump, or any other pump that can be used in heating or cooling systems, or the like.

The thermal sensor 132 and the one or more pressure sensors 134 can detect the temperature and pressure of the first fluid 116 within the first thermal shock circuit 114, respectively. The thermal sensor 132 can transmit a temperature signal to the pump controller 138, which can be indicative of the temperature of the first fluid 116 within the first thermal shock circuit 114. The first pressure sensor 134a can transmit a first pressure signal to the pump controller 138, which can be indicative of a first pressure of the first fluid 116 within the first thermal shock circuit 114. The second pressure sensor 134b can transmit a second pressure signal to the pump controller 138, which can be indicative of a second pressure of the first fluid 116 within the first thermal shock circuit 114. As shown in FIG. 1, the first pressure sensor 134a can detect the first pressure on a suction side of the pump 136 and the second pressure sensor 134b can detect the second pressure on the discharge side of the pump 136. In examples, the first pressure sensor 134a can detect the first pressure on the discharge side of the pump 136 and the second pressure sensor 134b can detect the second pressure on the suction side of the pump 136. The pump controller 138 can receive the temperature signal, the first pressure signal, and the second pressure signal, and can update the pumping rate of the pump 136 based on the received signals.

The second thermal shock circuit 140 can receive the second component 146 within the second chamber 144 for thermal shock testing. The second thermal shock circuit 140 can provide a second fluid 142 (e.g., glycol, glysantin G48, de-ionized water, any other cooling fluid, or the like) to the second chamber 144 to control the temperature of the second chamber 144 to a set threshold separate from the threshold(s) of the hot fluid supply circuit 102 and the cold fluid supply circuit 108. The second thermal shock circuit 140 can include the second chamber 144, a second heat exchanger 148, a reservoir 154, a pump 162, and one or more thermal sensors 158, and one or more pressure sensors 160 (e.g., a first pressure sensor 160a, a second pressure sensor 160b, and a nth pressure sensor 160n).

The second heat exchanger 148 can alternatively receive the hot fluid 106 or the cold fluid 112 on the shell side 150 of the the second heat exchanger 148 and transmit thermal energy to the second fluid 142 within the tube side 152 of the the second heat exchanger 148. The second heat exchanger 148 can be selectively fluidly connected to the hot fluid supply circuit 102 or the cold fluid supply circuit 108. The second heat exchanger 148 can transfer thermal energy from the hot fluid 106 or the cold fluid 112 to the second fluid 142 of the second thermal shock circuit 140. The second heat exchanger 148 can include a shell and tube heat exchanger including a shell side 150 and a tube side 152. The shell side 150 can include a routing through an outer shell of the heat exchanger 148. The tube side 152 can include a series of tubes extending within the outer shell of the heat exchanger 148. In examples, the shell side 150 and the tube side 152 can be fluidly isolated and thermally coupled so that fluid within one of the shell side 150 or the tube side 152 can heat or cool fluid in the other of the shell side 150 or the tube side 152.

The second heat exchanger 148 can receive the hot fluid 106 or the cold fluid 112 on the shell side 150 of the second heat exchanger 148 and transmit thermal energy to the second fluid 142 on the tube side 152. In examples, the second heat exchanger 148 can include other forms of heat exchangers (e.g., a plate heat exchanger, a finned tube heat exchanger, a double pipe heat exchanger, a scraped surface heat exchanger, or the like). The second thermal shock circuit 140 can also include multiple of the second heat exchangers 148 to further increase thermal heat transfer between the hot fluid 106, the cold fluid 112, and second fluid 142 of the second thermal shock circuit 140. For example, the second thermal shock circuit 140 can include a first of the second heat exchanger 148 fluidly connected between the hot fluid 106 and the second fluid 142 of the second thermal shock circuit 140 and a second of the second heat exchanger 148 fluidly connected between the cold fluid 112 and the second fluid 142 of the second thermal shock circuit 140.

The reservoir 154 can receive, store, and maintain a temperature of the second fluid 142 within the second thermal shock circuit 140. As shown in the example of the thermal shock system 100 shown in FIG. 1, the reservoir 154 can be fluidly connected to the second thermal shock circuit 140 between the second chamber 144 and the pump 162. The reservoir 154 can be fluidly connected to the second thermal shock circuit 140 between the pump 162 and the second heat exchanger 148, between the second heat exchanger 148 and the second chamber 144, between the hot fluid supply circuit 102 and the cold fluid supply circuit 108 and the second thermal shock circuit 140, or as a separate bypass that is used only when liquid needs to be added or removed from the second thermal shock circuit 140. As the reservoir 154 can maintain the temperature of the fluid within the second thermal shock circuit 140, the reservoir 154 can include insulation to help limit thermal transfer from the second fluid 142 to the environment surrounding the reservoir 154.

The valve 156 can be operable to control (e.g., permit or stop) flow to the second chamber 144. In examples, the valve 156 can be actuated to stop flow into the second chamber 144 such that the second chamber 144 can be emptied to change, engage with, or remove the second component 146. The valve 156 can also be configured to open to permit the second fluid 142 to flow into the second chamber 144. In examples, the valve 156 can be modular. The modular version of the valve 156 can be modulated to increase or decrease flow into the second chamber 144.

The pump 162 can pressurize the second fluid 142 within the second thermal shock circuit 140. The pump 162 can include a pump control 164, which can control the pumping rate of the pump 162. The pump 162 and the pump control 164 can control the pressure and flow rate of the second fluid 142 within the second thermal shock circuit 140. In examples, the pump 162 can include a centrifugal pump (e.g., an end-suction pump, vertical in-line pump, split-case pump, vertical multi-stage pump, or the like), rotodynamic pump, any other pump that can be used in heating or cooling systems, or the like. The pump 162 can include a pump control 164 to help control the pump speed based on input form one or more components of the second thermal shock circuit 140.

The thermal sensor 158 and the one or more pressure sensors 160 can detect the temperature and pressure of the second fluid 142 within the second thermal shock circuit 140, respectively. The thermal sensor 158 can transmit a temperature signal to the pump control 164, which can be indicative of the temperature of the second fluid 142 within the second thermal shock circuit 140. The first pressure sensor 160a can transmit a first pressure signal to the pump control 164, which can be indicative of a first pressure of the second fluid 142 within the second thermal shock circuit 140. The second pressure sensor 160b can transmit a second pressure signal to the pump control 164, which can be indicative of a second pressure of the second fluid 142 within the second thermal shock circuit 140. As shown in FIG. 1, the first pressure sensor 160a can detect the first pressure on a suction side of the pump 162 and the second pressure sensor 160b can detect the second pressure on the discharge side of the pump 162. In examples, the first pressure sensor 160a can detect the first pressure on the discharge side of the pump 162 and the 134b can detect the second pressure on the suction side of the pump 162. The pump control 164 can receive the temperature signal, the first pressure signal, and the second pressure signal, and update the pumping rate of the pump 162 based on the received signals.

A valve manifold 166 can alternatively direct the hot fluid 106 or the cold fluid 112 toward the first heat exchanger 122 or the second heat exchanger 148 to transfer thermal energy from the hot fluid 106 or the cold fluid 112 to the first fluid 116 or the second fluid 142. The valve manifold 166 can include a first hot fluid three-way valve 168, a first return three-way valve 170, a first cold fluid three-way valve 172, and a second return three-way valve 174.

The first hot fluid three-way valve 168 can be fluidly connected to the hot fluid supply circuit 102 and selectively fluidly connected to the first heat exchanger 122 or the second heat exchanger 148. The first return three-way valve 170 can be fluidly connected to an outlet of the first heat exchanger 122 and selectively fluidly connected to the cold fluid supply circuit 108 or the hot fluid supply circuit 102.

The first cold fluid three-way valve 172 can be fluidly connected to the cold fluid supply circuit 108 and selectively fluidly connected to the first heat exchanger 122 and the second heat exchanger 148. The second return three-way valve 174 can be fluidly connected to an outlet of the second heat exchanger 148 and selectively fluidly connected to the cold fluid supply circuit 108 and the hot fluid supply circuit 102.

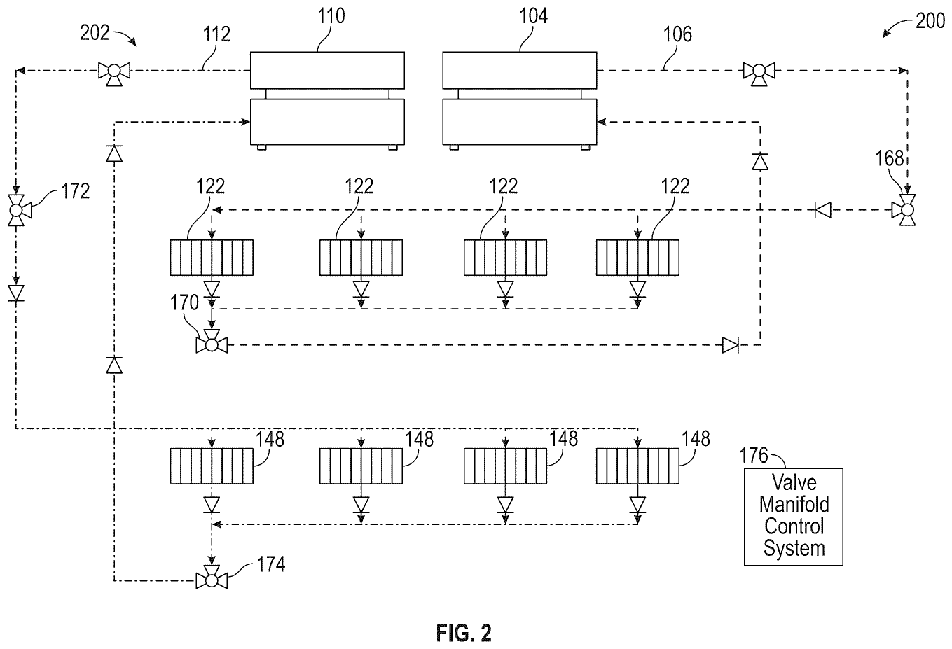

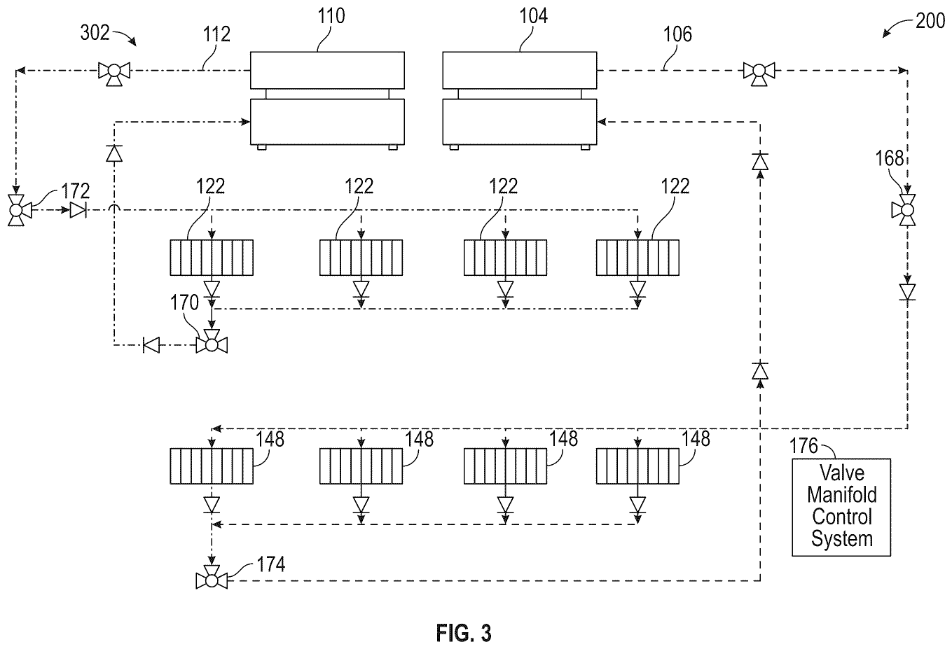

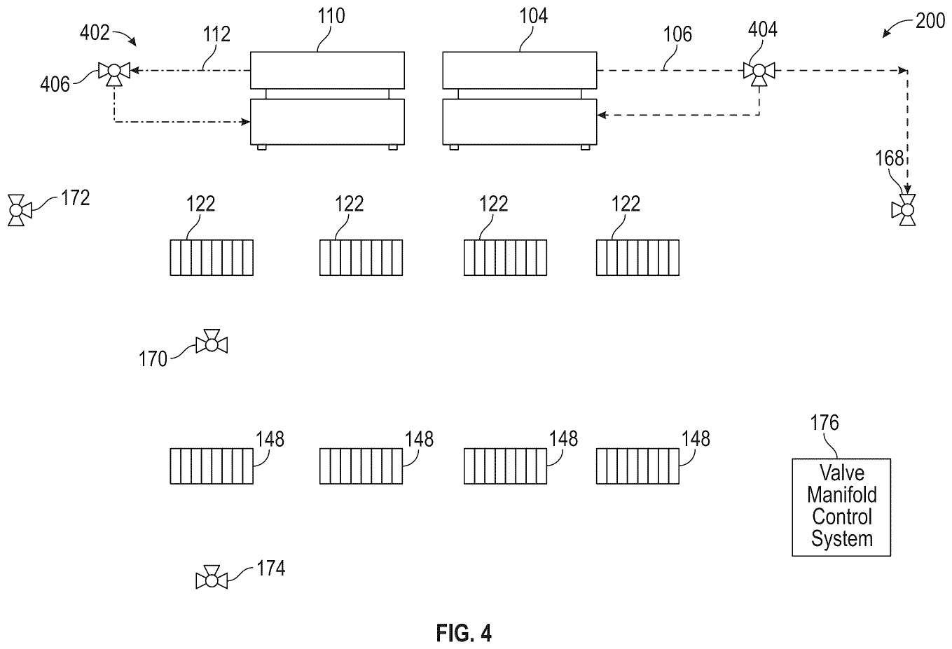

A valve manifold control system 176 can be in communication with the first hot fluid three-way valve 168, the first return three-way valve 170, the first cold fluid three-way valve 172, and the second return three-way valve 174 to control the valve manifold 166 between a first mode 202 (shown in FIG. 2), a second mode 302 (shown in FIG. 3), and a switching mode 402 (shown in FIG. 4).

In summary, the hot fluid source 104 and the cold fluid source 110 can provide hot fluid 106 and cold fluid 112, respectively, to at least one of the first heat exchanger 122 and the second heat exchanger 148, selectively. The first heat exchanger 122 and the second heat exchanger 148 can transfer thermal energy from the hot fluid 106 and the cold fluid 112 to the first fluid 116 and the second fluid 142, respectively. The first thermal shock circuit 114 can independently control the temperature and pressure of the first fluid 116 provided to the first component 120 within the first chamber 118. The second thermal shock circuit 140 can independently control the temperature and pressure of the second fluid 142 provided to the second component 146 in the second chamber 144. The valve manifold 166 and the valve manifold control system 176 can enable the thermal shock system 100 to operate between the different modes to alternatively cycle the temperature in the first chamber 118 and the second chamber 144. The thermal shock system 100 will be discussed in more detail herein with reference to FIG. 2-FIG. 8.

FIG. 2 illustrates a schematic diagram of an example of a thermal shock system 200 operating in a first mode 202, according to some examples. The thermal shock system 200 is an example of the thermal shock system 100 including four first heat exchangers 122 and second heat exchangers 148. Thus, the thermal shock system 200 can be fluidly connected to four first chambers 118 and four second chambers 144 such that eight components can undergo thermal shock testing simultaneously. As shown in FIG. 2, the valve manifold control system 176 can operate the thermal shock system 200 in the first mode 202.

In the first mode 202, the valve manifold control system 176 can fluidly connect the first hot fluid three-way valve 168 and the first heat exchangers 122 to direct the hot fluid 106 toward the first heat exchangers 122. The valve manifold control system 176 can fluidly connect the first return three-way valve 170 and the hot fluid supply circuits 102 to fluidly connect the first heat exchangers 122 and the hot fluid supply circuit 102.

In the first mode 202, the valve manifold control system 176 can also fluidly connect the first cold fluid three-way valve 172 and the second heat exchangers 148 to direct the cold fluid 112 toward the second heat exchangers 148. The valve manifold control system 176 can fluidly connect the second return three-way valve 174 and the cold fluid supply circuit 108 to fluidly connect the second heat exchangers 148 and the cold fluid supply circuit 108. The valve manifold control system 176 can also fluidly connect the second return three-way valve 174 and the cold fluid supply circuit 108 to fluidly connect the second heat exchangers 148 and the cold fluid supply circuit 108.Thus, in the first mode 202, the thermal shock system 200 can heat the components in the first chambers and cool the components in the second chambers.

FIG. 3 illustrates a schematic diagram of an example of a thermal shock system 200 (e.g., the thermal shock system 100) operating in a second mode 302, according to some examples. In the second mode 302, the valve manifold control system 176 can fluidly connect the first hot fluid three-way valve 168 and the second heat exchangers 148 to direct the hot fluid 106 toward the second heat exchangers 148. The valve manifold control system 176 can fluidly connect the second return three-way valve 174 to the hot fluid supply circuit 102 to fluidly connect the second heat exchangers 148 and the hot fluid supply circuit 102. The valve manifold control system 176, in the second mode 302, can fluidly connect the first cold fluid three-way valve 172 and the first heat exchangers 122 to direct the cold fluid 112 toward the first heat exchangers 122. In the second mode 302, the valve manifold control system 176 can fluidly connect the first return three-way valve 170 and the cold fluid supply circuit 108 to fluidly connect the first heat exchangers 122 and the cold fluid supply circuit 108. Thus, in the second mode 302, the thermal shock system 200 can heat the components in the second chambers and cool the components in the first chambers.

FIG. 4 illustrates a schematic diagram of an example of a thermal shock system 200 (e.g., the thermal shock system 100, see FIG. 1) operating in a switching mode 402, according to some examples. As shown in FIG. 4, the thermal shock system 200 (and the thermal shock system 100, shown in FIG. 1) can include a hot bypass three-way valve 404 and a cold bypass three-way valve 406. The hot bypass three-way valve 404 can be fluidly connected between the hot fluid source 104 and the first hot fluid three-way valve 168. The cold bypass three-way valve 406 can be fluidly connected between the cold fluid source 110 and the first cold fluid three-way valve 172.

In the switching mode 402, the valve manifold control system 176 can fluidly connect the hot fluid source 104 to the hot fluid source 104 to direct the hot fluid 106 from the hot fluid source 104 back to the hot fluid source 104 and bypass the first hot fluid three-way valve 168. In the switching mode 402, the valve manifold control system 176 can fluidly connect the cold fluid source 110 back to the cold fluid source 110 and bypass the first cold fluid three-way valve 172.

The valve manifold control system 176 can implement the switching mode 402 before changing the other valves (e.g., the first hot fluid three-way valve 168, the first return three-way valve 170, the first cold fluid three-way valve 172, and the second return three-way valve 174 between the first mode 202 and the second mode 302. The switching mode 402 helps prevent the mixing of the hot fluid 106 and the cold fluid 112 while switching between the first mode 202 and the second mode 302. Thus, the switching mode 402 helps control the temperature of the hot fluid 106 and the cold fluid 112 that are selectively provided to the first heat exchangers 122 and the second heat exchangers 148.

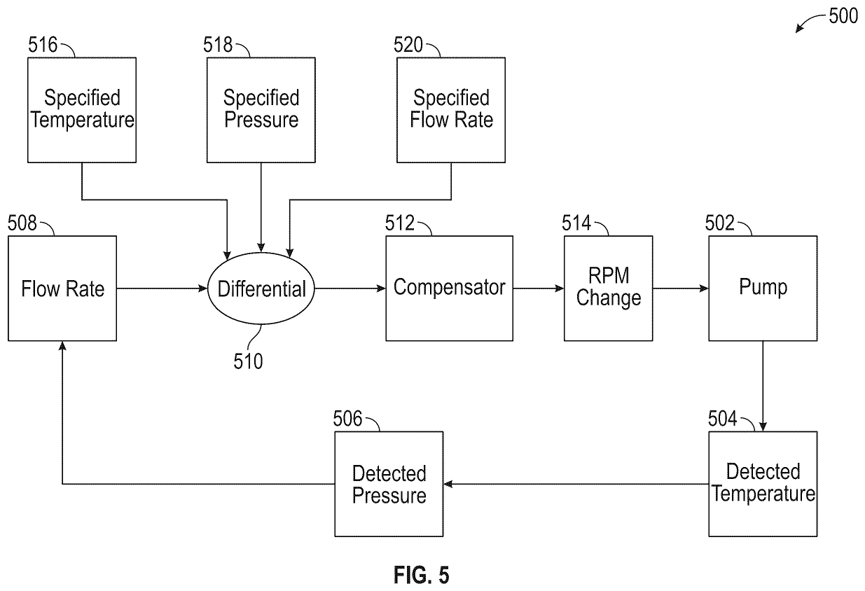

FIG. 5 illustrates a schematic diagram of an example of a calibration cycle 500 for a thermal shock circuit (e.g., the first thermal shock circuit 114 or the second thermal shock circuit 140, both in FIG. 1), according to some examples. As shown in FIG. 5, the calibration cycle 500 a pump 502 (e.g., the pump 136 or the pump 162, both shown in FIG. 1), a detected temperature 504 (e.g., from the thermal sensor 132 or the thermal sensor 158, both shown in FIG. 1), a detected pressure 506 (e.g., from the first pressure sensor 134a, the second pressure sensor 134b, the first pressure sensor 160a, or the second pressure sensor 160b, all shown in FIG. 1) a flow rate 508, a differential 510, a compensator 512, and a rotation per minute (RPM) change for the pump, hereinafter, RPM change 514. In examples, the calibration cycle 500 can be completed by the pump controller 138 (shown in FIG. 1) or any other controller, processor, or the like of the thermal shock system 100 (FIG. 1) or the thermal shock system 200 (FIG. 2).

The controller (e.g., the pump controller 138) can start the pump 502 at a known pumping rate. The pump controller 138 can then receive the detected temperature 504 indicative of the temperature of the fluid (e.g., the first fluid 116 or the second fluid 142, both shown in FIG. 1) within the first thermal shock circuit 114 or the second thermal shock circuit 140. The pump controller 138 can also receive the detected pressure 506 indicative of the pressure of the fluid within the first thermal shock circuit 114 or the second thermal shock circuit 140. Based on the detected temperature 504 and the detected pressure 506 of the fluid, the pump controller 138 can determine the flow rate 508 using one or more of the Bernoulli equation, the Poiseuille equation, or the like. In examples, the pump controller 138 can include a flow meter to separately detect the flow rate 508 of the fluid within the first thermal shock circuit 114 or the second thermal shock circuit 140.

The pump controller 138 can use one or more of the various detected conditions (e.g., from the sensors) and one or more settings or specified conditions to determine the differential 510. For example, the pump controller 138 can compare the detected temperature 504 to the specified temperature 516 to generate the differential 510. The pump controller 138 can also compare the detected pressure 506 to the specified pressure 518 to generate the differential 510. The pump controller 138 can compare the flow rate 508 to the specified flow rate 520 to generate the differential 510. In yet another example, the pump controller 138 can compare any combination of the detected temperature 504, the detected pressure 506, or the flow rate 508 to the specified temperature 516, the specified pressure 518, and the specified flow rate 520, respectively, to generate the differential 510.

The compensator 512 can receive the differential 510 (in any of its forms) and can lookup (e.g., via a look-up table, database, or the like) a learned change to decrease the differential and get the temperature detected by the detected temperature 504, the pressure detected by the detected pressure 506, or the flow rate 508 to match the specified temperature 516, the specified pressure 518, or the specified flow rate 520, and generate the RPM change 514. In examples, the compensator 512 can include communication with a convolutional neural network to analyze one or more of the detected temperature 504, the detected pressure 506, and the flow rate 508 and the specified temperature 516, the specified pressure 518, and the specified flow rate 520 to determine the RPM change 514. The pump controller 138 can transmit the RPM change 514 to the pump 502 to change the pumping rate of the pump 502 and calibrate the first thermal shock circuit 114 and the second thermal shock circuit 140 to the specified temperature 516, the specified pressure 518, and the specified flow rate 520.

The pump controller 138 can run the calibration cycle 500 twice for each of the first thermal shock circuit 114 and the second thermal shock circuit 140 to calibrate both the hot cycle and the cold cycle of the thermal shock testing. In examples, the pump controller 138 can run the calibration cycle 500 multiple times for each of the hot cycle and the cold cycle to help ensure the detected temperature 504, the detected pressure 506, and the flow rate 508 matches the specified temperature 516, the specified pressure 518, and the specified flow rate 520 for each side of the thermal shock testing. As the first thermal shock circuit 114 and the second thermal shock circuit 140 can be isolated from each other and can be selectively isolated from the hot fluid 106 and the cold fluid 112, the first thermal shock circuit 114 and the second thermal shock circuit 140 can quickly change between the cold calibration and the hot calibration as the thermal shock system 100 (or the thermal shock system 200) changes between the first mode 202 (FIG. 2) and the second mode 302 (FIG. 3). The efficient changes between the first mode 202 and the second mode 302 can help ensure the most dramatic thermal shock testing for the devices or components within the chambers.

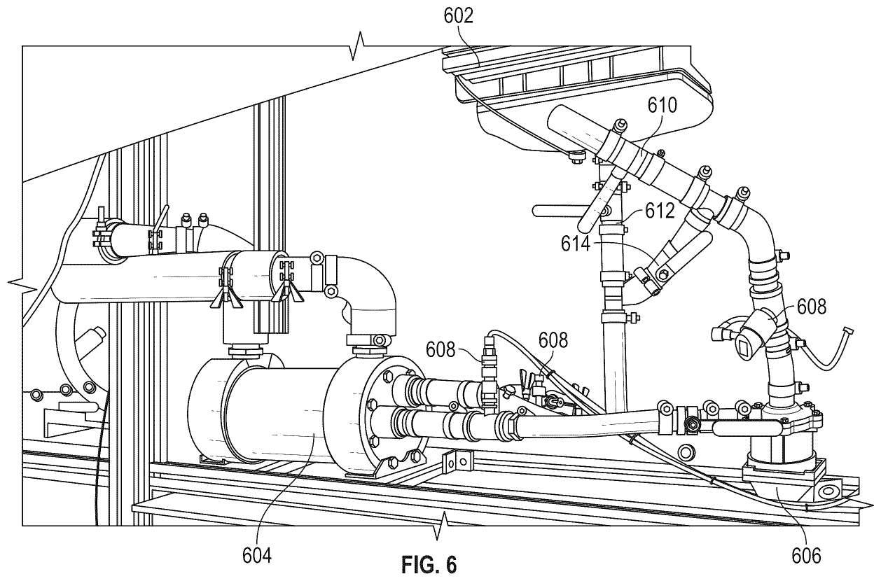

FIG. 6 illustrates a perspective view of an example of a thermal shock circuit 600 (e.g., the first thermal shock circuit 114 or the second thermal shock circuit 140), according to some examples. In examples, the thermal shock circuit 600 can include a reservoir 602 (e.g., the reservoir 128 or the reservoir 154, see FIG. 1), a heat exchanger 604 (e.g., the first heat exchanger 122 or the second heat exchanger 148, see FIG. 1), sensors 608 (e.g., the thermal sensor 132, the first pressure sensor 134a, the second pressure sensor 134b, the thermal sensor 158, the first pressure sensor 160a, the second pressure sensor 160b, or the like, see FIG. 1), a pump 606 (e.g., the pump 136, the pump 162, see FIG. 1), a source valve 610, a return valve 612, and a bypass valve 614.

The reservoir 602 can store the fluid within the thermal shock circuit 600. The heat exchanger 604 can conduct thermal energy between the hot fluid 106 (FIG. 1) and the cold fluid 112 (FIG. 1) to the fluid within the thermal shock circuit 600.

As discussed herein, the pump 606 can control the flow rate of the fluid within the thermal shock circuit 600 in isolation from the other fluid systems of the thermal shock system 100 or the thermal shock system 200. The source valve 610, the return valve 612, and the bypass valve 614 can control fluid flow within the thermal shock circuit 600. For example, the source valve 610 can fluidly isolate any of the reservoir 602, the heat exchanger 604, and the pump 606. The return valve 612 can fluidly isolate the reservoir 602. The bypass valve 614 can fluidly connect the reservoir 602 to the reservoir 602 to bypass the heat exchanger 604 and the pump 606 to maintain the temperature and pressure of the fluid within the reservoir 602.

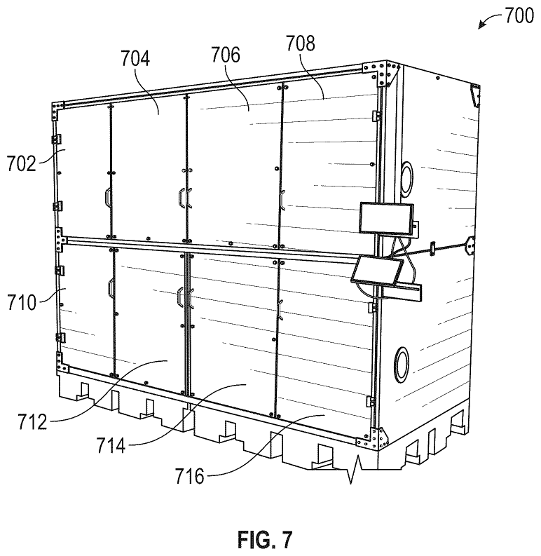

FIG. 7 illustrates a perspective view of an example of a chamber bank 700, according to some examples. The chamber bank 700 can include a first chamber 702, a second chamber 704, a third chamber 706, a fourth chamber 708, a fifth chamber 710, a sixth chamber 712, a seventh chamber 714, and an eighth chamber 716. Each of the chambers (e.g., the first chamber 702, the second chamber 704, the third chamber 706, the fourth chamber 708, the fifth chamber 710, the sixth chamber 712, the seventh chamber 714, and the eighth chamber 716) can include the thermal shock circuit 600 (FIG. 6), and as such, can be fluidly isolated from one another. As the chambers can be fluidly isolated, a failure in the thermal shock circuit 600 relating to a single chamber does not change or affect the components in another chamber of the thermal shock circuit 600 (FIG. 6). In examples, the first chamber 702, the second chamber 704, the third chamber 706, and the fourth chamber 708 can be fluidly connected to the first thermal shock circuit 114 and the fifth chamber 710, the sixth chamber 712, the seventh chamber 714, and the eighth chamber 716 can be fluidly connected to the second thermal shock circuit 140. In another example, all of the first chamber 702, the second chamber 704, the third chamber 706, the fourth chamber 708, the fifth chamber 710, the sixth chamber 712, the seventh chamber 714, and the eighth chamber 716 can be attached to either of the first thermal shock circuit 114 or the second thermal shock circuit 140 and another chamber bank 700 can be connected to the other of the first thermal shock circuit 114 or the second thermal shock circuit 140.

In examples, the chambers (e.g., the first chamber 702, the second chamber 704, the third chamber 706, the fourth chamber 708, the fifth chamber 710, the sixth chamber 712, the seventh chamber 714, and the eighth chamber 716) can be combinable to accommodate components or devices that are larger than any one of the chambers. For example, the first chamber 702 and the second chamber 704 can be combinable, or the first chamber 702, the second chamber 704, and the third chamber 706 can be combinable, or the first chamber 702, the second chamber 704, the third chamber 706, and the fourth chamber 708 can be combinable. Similarily, the fifth chamber 710 and the sixth chamber 712 can be combinable, or the fifth chamber 710, the sixth chamber 712, and the seventh chamber 714 can be combinable, or the fifth chamber 710, the sixth chamber 712, the seventh chamber 714, and the eighth chamber 716 can be combinable.

In examples, the first chamber 702 and the fifth chamber 710 can be combinable. The second chamber 704 and the sixth chamber 712 can be combinable. The third chamber 706 and the seventh chamber 714 can be combinable. The fourth chamber 708 and the eighth chamber 716 can be combinable. The first chamber 702 and the second chamber 704 can be combinable with the fifth chamber 710 and the sixth chamber 712. The first chamber 702, the second chamber 704, and the third chamber 706 can be combinable with the fifth chamber 710, the sixth chamber 712, and the seventh chamber 714. The first chamber 702, the second chamber 704, the third chamber 706, and the third chamber 706 can be combinable with the fifth chamber 710, the sixth chamber 712, the seventh chamber 714, and the eighth chamber 716.

As each of the chambers (e.g., the first chamber 702, the second chamber 704, the third chamber 706, the fourth chamber 708, the fifth chamber 710, the sixth chamber 712, the seventh chamber 714, and the eighth chamber 716) can be fluidly isolated, a systemic failure of any of the components within any of the chambers does not effect the testing results of components within the other chambers.

The combinations discussed herein are just examples of the modularity of the chamber bank 700 and are not intended to be an exhaustive list of the possible combinations of the chambers. However, for the purpose of efficiency, the present disclosure will not list all possible combinations but will discuss that any combination of chambers can be combined to adjust the size and shape of components or devices that can receive thermal shock testing within the chamber bank 700.

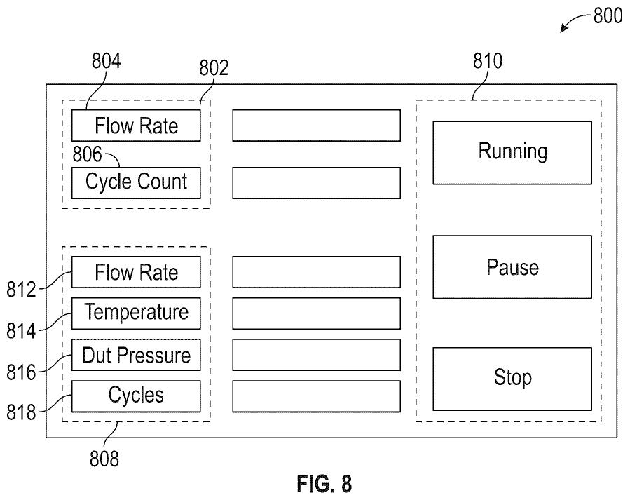

FIG. 8 illustrates an example of a graphical user interface 800, according to some examples. The graphical user interface 800 can help the thermal shock system 100 or the thermal shock system 200 communicate with a user of the systems. The graphical user interface 800 can include user inputs 802, job specific information 808, and operation commands 810.

As shown in FIG. 8, the user inputs 802 can include a flow rate 804 (e.g., the specified flow rate 520, see FIG. 5) and a cycle count 806. The flow rate 804 can be a set flow rate to obtain the desired temperatures and pressures within the chamber for thermal shock testing the component therein. The cycle count 806 can include the number of total cycles (e.g., rotations between hot and cold thermal shock testing) the components will undergo during the thermal shock testing. In examples, the user inputs 802 can include one or more of the specified temperature 516, the specified pressure 518, the specified flow rate 520 and the cycle count 806.

The job specific information 808 can include pump speed 812, detected temperature 814, device under testing pressure 816, and the completed cycles 818. This information can be updated via a controller (e.g., the pump controller 138, see FIG. 1, or any other controller of the thermal shock system 100, see FIG. 1, or the thermal shock system 200, see FIG. 2). The operation commands 810 enables the end user to start, pause, or stop the thermal shock testing.

The graphical user interface 800 is just one example of a graphical user interface and is not intended to be a limiting disclosure. The present disclosure appreciates that many graphical user interfaces can be used to operate any of the thermal shock system 100 (FIG. 1) or the thermal shock system 200 (FIG. 2).

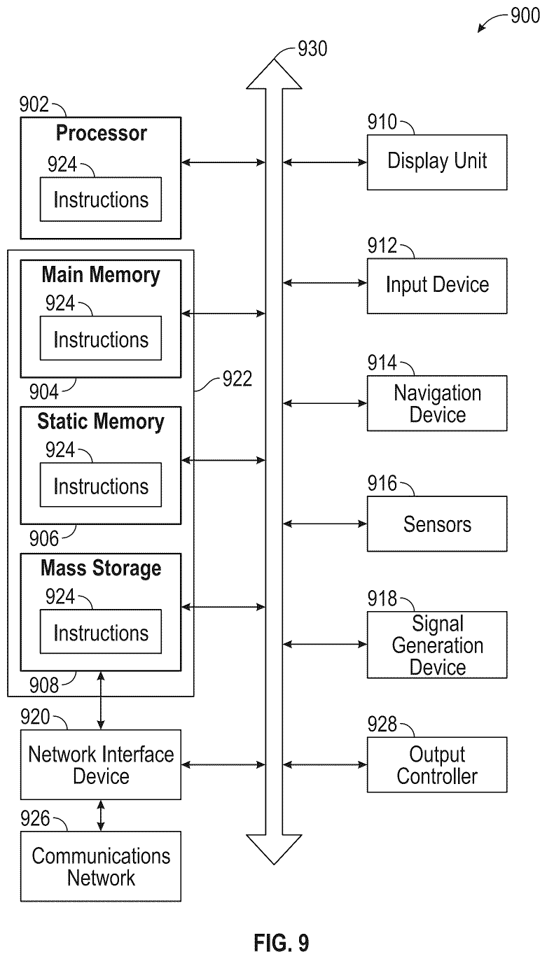

FIG. 9 illustrates a block diagram of an example machine 900 upon which any one or more of the techniques (e.g., methodologies) discussed herein can perform, according to some examples. Examples, as described herein, can include, or can operate by, logic or a number of components, or mechanisms in the machine 900. Circuitry (e.g., processing circuitry) is a collection of circuits implemented in tangible entities of the machine 900 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.), including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 900 follow.

In alternative examples, the machine 900 can operate as a standalone device or can be connected (e.g., networked) to other machines. In a networked deployment, the machine 900 can operate in the capacity of a server machine, a client machine, or both in server-client network environments. In an example, the machine 900 can act as a peer machine in peer-to-peer (P2P) (or other distributed) network environment. The machine 900 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 900 can include a hardware processor 902 (e.g., a central processing unit (CPU), a graphics processing unit (GPU), a hardware processor core, or any combination thereof), a main memory 904, a static memory (e.g., memory or storage for firmware, microcode, a basic-input-output (BIOS), and mass storage 908 (e.g., hard drives, tape drives, flash storage, or other block devices) some or all of which can communicate with each other via an interlink 930 (e.g., bus). The machine 900 can further include a display unit 910, an alphanumeric input device 912 (e.g., a keyboard), and a user interface (UI) navigation device 914 (e.g., a mouse). In examples, the display unit 910, input device 912 and UI navigation device 914 can be a touch screen display. The machine 900 can additionally include a signal generation device 918 (e.g., a speaker), a network interface device 920, and one or more sensors 916, such as a global positioning system (GPS) sensor, compass, accelerometer, or other sensor. The machine 900 can include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 902, the main memory 904, the static memory 906, or the mass storage 908 can be, or include, a machine-readable medium 922 on which is stored one or more sets of data structures or instructions 924 (e.g., software) embodying or utilized by any one or more of the techniques or functions described herein. The instructions 924 can also reside, completely or at least partially, within any of registers of the processor 902, the main memory 904, the static memory 906, or the mass storage 908 during execution thereof by the machine 900. In an example, one or any combination of the hardware processor 902, the main memory 904, the static memory 906, or the mass storage 908 can constitute the machine-readable media 922. While the machine-readable medium 922 is illustrated as a single medium, the term “machine-readable medium” can include a single medium or multiple media (e.g., a centralized or distributed database, and/or associated caches and servers) configured to store the one or more instructions 924.

The term “machine-readable medium” can include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine-readable media that do not include transitory propagating signals. Specific examples of non-transitory machine-readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine-readable medium 922 can be representative of the instructions 924, such as instructions 924 themselves or a format from which the instructions 924 can be derived. This format from which the instructions 924 can be derived can include source code, encoded instructions (e.g., in compressed or encrypted form), packaged instructions (e.g., split into multiple packages), or the like. The information representative of the instructions 924 in the machine-readable medium 922 can be processed by processing circuitry into the instructions to implement any of the operations discussed herein. For example, deriving the instructions 924 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 924.

In an example, the derivation of the instructions 924 can include assembly, compilation, or interpretation of the information (e.g., by the processing circuitry) to create the instructions 924 from some intermediate or preprocessed format provided by the machine-readable medium 922. The information, when provided in multiple parts, can be combined, unpacked, and modified to create the instructions 924. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable, etc.) at a local machine, and executed by the local machine.

The instructions 924 can be further transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 920 can include one or more physical jacks (e.g., Ethernet, coaxial, or phone jacks) or one or more antennas to connect to the communications network 926. In an example, the network interface device 920 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software. A transmission medium is a machine-readable medium.

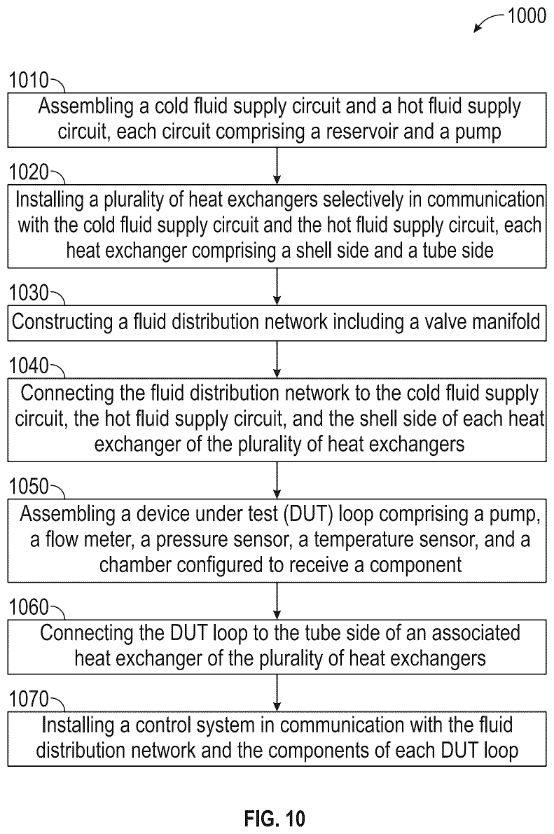

FIG. 10 illustrates a block diagram of an example method 1000, according to some examples. The thermal shock systems described herein (e.g., the thermal shock system 100 shown in FIG. 1 and the thermal shock system 200 shown in FIG. 2) can be manufactured using the method 1000. The method 1000 can optionally include one or more of operations 1010-1070.

At operation 1010, the method 1000 can include assembling a cold fluid supply circuit (e.g., the cold fluid supply circuit 108, see FIG. 1) and a hot fluid supply circuit (e.g., the hot fluid supply circuit 102, see FIG. 1). Each circuit of the cold fluid circuit and the hot fluid supply circuit can include reservoirs (e.g., the cold fluid source 110 and the hot fluid source 104, see FIG. 1), pumps, and associated plumbing to store and circulate the cold fluid 112 and hot fluid 106 respectively.

At operation 1020, the method 1000 can optionally include installing a plurality of heat exchangers (e.g., first heat exchanger 122 and second heat exchanger 148, see FIG. 1) in communication with one or more of the hot fluid supply circuit, the cold fluid supply circuit, or the test chambers (e.g., the first chamber 118 and the second chamber 144, see FIG. 1). Each heat exchanger can be configured with a shell side (e.g., the shell side 124, FIG. 1) and a tube side (e.g., the tube side 126, FIG. 1). The shell sides can be connected to the fluid distribution network, while the tube sides can be connected to individual device under test (DUT) loops.

At operation 1030, the method 1000 can include constructing a fluid distribution network. The fluid distribution network can include a valve switching manifold 166 (FIG. 1). The fluid distribution network can then be constructed and connected to the cold and hot fluid supply circuits and the shell sides of the heat exchangers.

At operation 1040, the method 1000 can optionally include connecting the fluid distribution network to the hot fluid supply circuit and the cold fluid supply circuit by way of one or more valves (e.g., the first hot fluid three-way valve 168, the first return three-way valve 170, the first cold fluid three-way valve 172, and the second return three-way valve 174, all shown in FIG. 1) and plumbing to allow selective routing of cold and hot fluids to different groups of heat exchangers.

At operation 1050, the method 1000 can include assembling a DUT loop for each chamber. Each chamber can be configured to receive a component for thermal shock testing. Each DUT loop can include a pump (e.g., the pump 136 or the pump 162, see FIG. 1), flow meters, pressure sensors (e.g., first pressure sensor 134a, second pressure sensor 134b, the first pressure sensor 160a, or the second pressure sensor 160b, see FIG. 1), temperature sensor (e.g., thermal sensor 132 or the thermal sensor 158, see FIG. 1), and associated plumbing.

At operation 1060, the method 1000 can include connecting the DUT loop to the tube side of its associated heat exchanger.

At operation 1070, the method 1000 can include installing a control system (e.g., the valve manifold control system 176). The control system can be connected to the fluid distribution network and the components of each DUT loop. This control system can include processors, memory, and input/output interfaces to enable the control functions described herein.

Finally, the system can be charged with appropriate fluids, calibrated, and tested to ensure proper operation. This can include performing initial calibration cycles for each DUT loop to determine optimal pump settings across the intended range of fluid temperatures.

The manufacturing process can be modular, allowing for the addition of test chambers and associated components to scale the system as needed. The system can also be configured to accommodate different sizes of test chambers or combinations of chambers to suit various testing requirements. Moreover, the method can be implemented in any order or sequence.

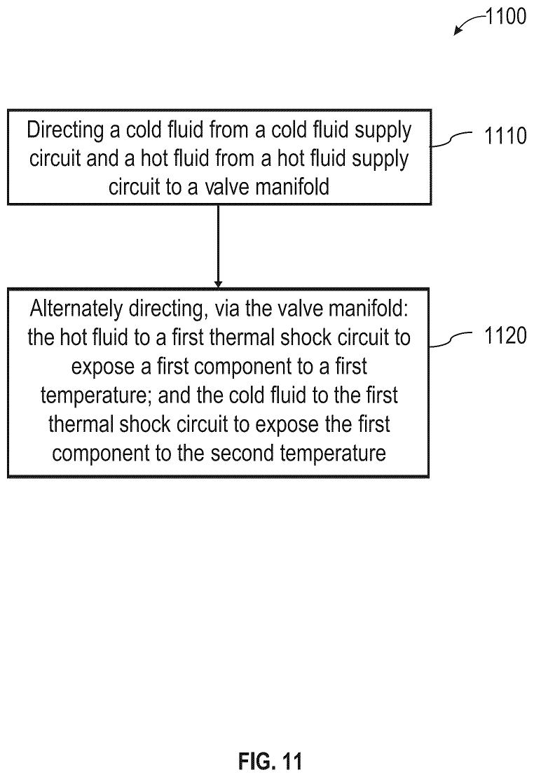

FIG. 11 illustrates a block diagram of an example of a method 1100. The method 1100 can be a method of operating a thermal shock system (e.g., the thermal shock system 100, see FIG. 1, the thermal shock system 200, see FIG. 2, or the like). The method 1100 can optionally include operations 1110 and 1120.

At operation 1110, the method 1100 can include directing a cold fluid from a cold fluid supply circuit and a hot fluid from a hot fluid supply circuit to a valve manifold.

At operation 1110, the method 1100 can include directing a cold fluid from a cold fluid supply circuit (e.g., the cold fluid supply circuit 108, see FIG. 1) and a hot fluid from a hot fluid supply circuit (e.g., the hot fluid supply circuit 102, see FIG. 1) to a valve manifold (e.g., the valve manifold 166, see FIG. 1).

The cold fluid supply circuit 108 can deliver or provide a cold fluid 112 (e.g., glycol, glysantin G48, de-ionized water, any other cooling fluid, or the like) to the thermal shock system 100. The cold fluid supply circuit 108 can include a cold fluid source 110 (e.g., a chiller, air conditioner, cooling tower, other cooling means, or the like) to cool the cold fluid 112 to a set threshold temperature. The cold fluid supply circuit 108 can include one or more pumps to deliver the cold fluid 112 to the first thermal shock circuit 114 or the second thermal shock circuit 140 at a consistent temperature and pressure. The valve manifold 166 can alternatively direct the hot fluid 106 or the cold fluid 112 toward at least one of the first heat exchanger 122 or the second heat exchanger 148 to transfer thermal energy from the hot fluid 106 or the cold fluid 112 to the first fluid 116 or the second fluid 142.

At operation 1120, the method 1100 can include alternately directing, via the valve manifold (e.g., the valve manifold 166, see FIG. 1) the hot fluid to at least one of a first thermal shock circuit (e.g., the first thermal shock circuit 114, see FIG. 1), a second thermal shock circuit (e.g., the second thermal shock circuit 140, see FIG. 1), or any other thermal shock circuit and the cold fluid to the other of the first thermal shock circuit, the second thermal shock circuit, or any other thermal shock circuit to expose at least one component to a second temperature. The first temperature can be higher than the second temperature.

The following non-limiting examples detail certain aspects of the present subject matter that solve the challenges and provide the benefits discussed herein, among other things.

Example 1 is a thermal shock system for testing two components at the same in different chambers, comprising: a cold fluid supply circuit to deliver a cold fluid; a hot fluid supply circuit to deliver a hot fluid; a first thermal shock circuit configured to receive a first component for thermal shock testing, the first thermal shock circuit configured to expose the first component to a first temperature and a first pressure; a second thermal shock circuit configured to receive a second component for thermal shock testing, the second thermal shock circuit configured to expose the second component to a second temperature and a second pressure; and a valve manifold configured to alternately direct the cold fluid and the hot fluid to the first thermal shock circuit and the second thermal shock circuit.

In Example 2, the subject matter of Example 1 optionally includes wherein the first thermal shock circuit comprises: a first chamber configured to receive the first component for thermal shock testing; and a first heat exchanger fluidly connected to the cold fluid supply circuit, the hot fluid supply circuit, and the first thermal shock circuit, the first heat exchanger configured to transfer thermal energy from the cold fluid and the hot fluid to the first thermal shock circuit.

In Example 3, the subject matter of Example 2 optionally includes wherein the first heat exchanger includes a shell and tube heat exchanger, a tube side of the shell and tube heat exchanger is connected to the first thermal shock circuit, and a shell side of the shell and tube heat exchanger is connected to the hot fluid supply circuit and the cold fluid supply circuit.

In Example 4, the subject matter of any one or more of Examples 2-3 optionally include wherein the first thermal shock circuit: a pump configured to pump a fluid through the first thermal shock circuit; a flow meter configured to detect a flow rate of the fluid flowing through the first thermal shock circuit; a pressure sensor configured to detect the first pressure within the first thermal shock circuit; and a thermal sensor configured to detect the first temperature within the first thermal shock circuit.

In Example 5, the subject matter of Example 4 optionally includes wherein the first thermal shock circuit comprises: a control system configured to independently control the flow rate of fluid flow through the first thermal shock circuit to adjust the first temperature and the first pressure within the first thermal shock circuit based on feedback from one or more of the pump, the flow meter, the pressure sensor, or the thermal sensor.

In Example 6, the subject matter of Example 5 optionally includes wherein the control system is configured to perform a calibration cycle to control the first thermal shock circuit to a specified flow rate, a specified pressure, and a specified temperature, and wherein, in the calibration cycle, the control system is configured to: transmit a start pump signal to the pump to set the pump to a known pumping rate; generate, based on comparing one or more of the specified flow rate and the flow rate of the fluid flowing through the first thermal shock circuit, the specified temperature and the first temperature, or the specified pressure and the first pressure, a delta value; determine, based on the delta value, an updated pumping rate; and transmitting, based on the updated pumping rate, a control signal to set the pump to the updated pumping rate.

In Example 7, the subject matter of any one or more of Examples 2-6 optionally include wherein the second thermal shock circuit comprises: a second chamber configured to receive the second component for thermal shock testing; and a second heat exchanger fluidly connected to the cold fluid supply circuit, the hot fluid supply circuit, and the second thermal shock circuit, the second heat exchanger configured to transfer thermal energy from the cold fluid and the hot fluid to the second thermal shock circuit.

In Example 8, the subject matter of Example 7 optionally includes wherein the second heat exchanger includes a shell and tube heat exchanger, a tube side of the shell and tube heat exchanger is connected to the second thermal shock circuit, and a shell side of the shell and tube heat exchanger is connected to the hot fluid supply circuit and the cold fluid supply circuit.

In Example 9, the subject matter of any one or more of Examples 7-8 optionally include wherein the second thermal shock circuit comprises: a pump configured to pump a fluid through the second thermal shock circuit; a flow meter configured to detect a flow rate of the fluid flowing through the second thermal shock circuit; a pressure sensor configured to detect the second pressure within the second thermal shock circuit; and a thermal sensor configured to detect the second temperature within the second thermal shock circuit.

In Example 10, the subject matter of Example 9 optionally includes wherein the second thermal shock circuit comprises: a control system configured to independently control the flow rate of fluid flow through the second thermal shock circuit to adjust the second temperature and the second pressure within the second thermal shock circuit based on feedback from one or more of the pump, the flow meter, the pressure sensor, or the thermal sensor.

In Example 11, the subject matter of Example 10 optionally includes wherein the control system is configured to perform a calibration cycle to control the second thermal shock circuit to a specified flow rate, a specified pressure, and a specified temperature, and wherein, in the calibration cycle, the control system is configured to: transmit a start pump signal to the pump to set the pump to a known pumping rate; generate, based on comparing one or more of the specified flow rate and the flow rate of the fluid flowing through the second thermal shock circuit detected by the flow meter, the specified temperature and the second temperature, or the specified pressure and the second pressure, a delta value; determine, based on the delta value, an updated pumping rate; and transmitting, based on the updated pumping rate, a control signal to set the pump to the updated pumping rate.

In Example 12, the subject matter of any one or more of Examples 7-11 optionally include wherein the valve manifold comprises: a first cold fluid three-way valve fluidly connected to the cold fluid supply circuit and selectively fluidly connected to the first heat exchanger and the second heat exchanger; a first hot fluid three-way valve fluidly connected to the hot fluid supply circuit and selectively fluidly connected to the first heat exchanger and the second heat exchanger; a first return three-way valve fluidly connected to an outlet of the first heat exchanger and selectively fluidly connected to the cold fluid supply circuit and the hot fluid supply circuit; and a second return three-way valve fluidly connected to an outlet of the second heat exchanger and selectively fluidly connected to the cold fluid supply circuit and the hot fluid supply circuit.

In Example 13, the subject matter of Example 12 optionally includes a control system configured to operate the valve manifold between a first mode and a second mode; wherein, in the first mode, the control system fluidly connects the first hot fluid three-way valve and the first heat exchanger to direct the hot fluid toward the first heat exchanger; wherein, in the first mode, the control system fluidly connects the first return three-way valve and the hot fluid supply circuit to fluidly connect the first heat exchanger and the hot fluid supply circuit; wherein, in the first mode, the control system fluidly connects the first cold fluid three-way valve and the second heat exchanger to direct the cold fluid toward the second heat exchanger; wherein, in the first mode, the control system fluidly connects the second return three-way valve and the cold fluid supply circuit to fluidly connect the second heat exchanger and the cold fluid supply circuit; wherein, in the second mode, the control system fluidly connects the first hot fluid three-way valve and the second heat exchanger to direct the hot fluid toward the second heat exchanger; wherein, in the second mode, the control system fluidly connects the second return three-way valve to the hot fluid supply circuit to fluidly connect the second heat exchanger and the hot fluid supply circuit; wherein, in the second mode, the control system fluidly connects the first cold fluid three-way valve and the first heat exchanger to direct the cold fluid toward the first heat exchanger; and wherein, in the second mode, the control system fluidly connects the first return three-way valve and the cold fluid supply circuit to fluidly connect the first heat exchanger and the cold fluid supply circuit.

In Example 14, the subject matter of Example 13 optionally includes wherein the valve manifold comprises: a cold bypass three-way valve fluidly connected to the cold fluid supply circuit and selectively fluidly connected to the first cold fluid three-way valve and the cold reservoir; and a hot bypass three-way valve fluidly connected to the hot fluid supply circuit and selectively fluidly connected to the first hot fluid three-way valve and the hot reservoir.

In Example 15, the subject matter of Example 14 optionally includes wherein the control system is configured to operate the valve manifold in a switching mode; wherein, in the switching mode, the control system fluidly connects the cold bypass three-way valve to the cold fluid supply circuit to bypass the first cold fluid three-way valve; and wherein, in the switching mode, the control system fluidly connects the hot bypass three-way valve and the hot fluid supply circuit to bypass the first hot fluid three-way valve.

Example 16 is a thermal shock system for testing two or more components at the same in different chambers, comprising: a cold fluid supply circuit to deliver a cold fluid; a hot fluid supply circuit to deliver a hot fluid; a plurality of test chambers, each test chamber of the plurality of test chambers including a heat exchanger with a primary side and a secondary side; a fluid distribution network configured to selectively route the cold fluid and the hot fluid to the primary side of the heat exchangers; a plurality of device under test circuits; each device under test circuit of the plurality of device under test circuits connected to the secondary side of the heat exchanger and configured to circulate fluid to a component within the respective test chamber of the plurality of test chambers; and a control system configured to: control the fluid distribution network to alternatively expose the plurality of device under test circuits to the cold fluid and the hot fluid via the heat exchangers; and independently control fluid flow in each device under test circuit of the plurality of device under test circuits.

In Example 17, the subject matter of Example 16 optionally includes wherein the plurality of test chambers comprises: a first group of test chambers; and a second group of test chambers; and wherein, the control system is configured to alternatively expose the first group of test chambers to one of the hot fluid or the cold fluid and the second group of test chambers to the other of the hot fluid or the cold fluid.

In Example 18, the subject matter of Example 17 optionally includes wherein the fluid distribution network is operable between a first mode, a second mode, and a switching mode; wherein: in the first mode, the fluid distribution network is configured to direct the hot fluid to the first group of test chambers and the cold fluid to the second group of test chambers; in the second mode, the fluid distribution network is configured to direct the cold fluid to the first group of test chambers and the hot fluid to the second group of test chambers; and in the switching mode, the fluid distribution network is configured to the fluid distribution network short circuits the cold fluid supply circuit and the hot fluid supply circuit to prevent the cold fluid and the hot fluid from flowing through the rest of the fluid distribution network.

In Example 19, the subject matter of any one or more of Examples 16-18 optionally include wherein each device under test circuit comprises: a pump; a flow meter to generate a flow signal indicative of a detected flow of fluid in the device under test circuit; a pressure sensor to generate a pressure signal indicative of a detected pressure within the device under test circuit; and a temperature sensor to generate a temperature signal indicative of a detected pressure within the device under test circuit; wherein the control system is configured to receive the flow signal, the pressure signal, and the temperature signal and control the flow through the device under test circuit independently from other device under test circuits of the plurality of device under test circuits.

In Example 20, the subject matter of Example 19 optionally includes wherein the control system is configured to perform an air purge routine for each device under test circuit by cycling the pump of each device under test circuit between a maximum speed and a minimum speed to remove air from the thermal shock system.

Example 21 is a thermal shock system for testing components, the thermal shock system comprising: a cold fluid supply circuit configured to deliver a cold fluid; a hot fluid supply circuit configured to deliver a hot fluid; a heat exchanger fluidly connected to the cold fluid supply circuit, the hot fluid supply circuit; a valve manifold fluidly coupled to the cold fluid supply circuit and the hot fluid supply circuit; and a thermal shock circuit coupled to the valve manifold, wherein: the thermal shock circuit is configured to receive a component for thermal shock testing; the thermal shock circuit includes a tertiary fluid that is selectively thermally coupled, via the heat exchanger, to the cold fluid or the hot fluid based at least in part on a configuration of the valve manifold; the thermal shock circuit is configured to expose the component to a temperature based at least in part on the valve manifold being in a configuration to thermally couple the tertiary fluid with the cold fluid; and the thermal shock circuit is configured to expose the component to a second temperature based at least in part on the valve manifold being in a second configuration to thermally couple the tertiary fluid with the hot fluid.

In Example 22, the subject matter of Example 21 optionally includes a plurality of test chambers, each test chamber of the plurality of test chambers including a heat exchanger with a primary side and a secondary side; a fluid distribution network configured to selectively route the cold fluid and the hot fluid to the primary side of the heat exchangers; a plurality of device under test circuits; each device under test circuit of the plurality of device under test circuits connected to the secondary side of the heat exchanger and configured to circulate fluid to a component within the respective test chamber of the plurality of test chambers; and a control system configured to: control the fluid distribution network to alternatively expose the plurality of device under test circuits to the cold fluid and the hot fluid via the heat exchangers; and independently control fluid flow in each device under test circuit of the plurality of device under test circuits.

In Example 23, the subject matter of any one or more of Examples 21-22 optionally include wherein the thermal shock system further compriess: a second thermal shock circuit including: a second chamber configured to receive a second component for thermal shock testing; and a second heat exchanger fluidly connected to the cold fluid supply circuit, the hot fluid supply circuit, and the second thermal shock circuit, the second heat exchanger configured to transfer thermal energy from the cold fluid and the hot fluid to the second thermal shock circuit.

In Example 24, the subject matter of Example 23 optionally includes wherein the second heat exchanger includes a shell and tube heat exchanger, a tube side of the shell and tube heat exchanger is connected to the second thermal shock circuit, and a shell side of the shell and tube heat exchanger is connected to the hot fluid supply circuit and the cold fluid supply circuit.

In Example 25, the subject matter of any one or more of Examples 23-24 optionally include wherein the second thermal shock circuit comprises: a pump configured to pump a fluid through the second thermal shock circuit; a flow meter configured to detect a flow rate of the fluid flowing through the second thermal shock circuit; a pressure sensor configured to detect a second pressure within the second thermal shock circuit; and a thermal sensor configured to detect a second temperature within the second thermal shock circuit.

In Example 26, the subject matter of Example 25 optionally includes wherein the second thermal shock circuit comprises: a control system configured to independently control the flow rate of fluid flow through the second thermal shock circuit to adjust the second temperature and the second pressure within the second thermal shock circuit based on feedback from one or more of the pump, the flow meter, the pressure sensor, or the thermal sensor.

In Example 27, the subject matter of any one or more of Examples 23-26 optionally include wherein the valve manifold comprises: a first cold fluid three-way valve fluidly connected to the cold fluid supply circuit and selectively fluidly connected to the heat exchanger and the second heat exchanger; a first hot fluid three-way valve fluidly connected to the hot fluid supply circuit and selectively fluidly connected to the heat exchanger and the second heat exchanger; a first return three-way valve fluidly connected to an outlet of the heat exchanger and selectively fluidly connected to the cold fluid supply circuit and the hot fluid supply circuit; and a second return three-way valve fluidly connected to an outlet of the second heat exchanger and selectively fluidly connected to the cold fluid supply circuit and the hot fluid supply circuit.

In Example 28, the subject matter of Example 27 optionally includes a control system configured to operate the valve manifold between a first mode and a second mode, wherein: in the first mode, the control system fluidly connects the first hot fluid three-way valve and the heat exchanger to direct the hot fluid toward the heat exchanger; in the first mode, the control system fluidly connects the first return three-way valve and the hot fluid supply circuit to fluidly connect the heat exchanger and the hot fluid supply circuit; in the first mode, the control system fluidly connects the first cold fluid three-way valve and the second heat exchanger to direct the cold fluid toward the second heat exchanger; in the first mode, the control system fluidly connects the second return three-way valve and the cold fluid supply circuit to fluidly connect the second heat exchanger and the cold fluid supply circuit; in the second mode, the control system fluidly connects the first hot fluid three-way valve and the second heat exchanger to direct the hot fluid toward the second heat exchanger; in the second mode, the control system fluidly connects the second return three-way valve to the hot fluid supply circuit to fluidly connect the second heat exchanger and the hot fluid supply circuit; in the second mode, the control system fluidly connects the first cold fluid three-way valve and the heat exchanger to direct the cold fluid toward the heat exchanger; and in the second mode, the control system fluidly connects the first return three-way valve and the cold fluid supply circuit to fluidly connect the heat exchanger and the cold fluid supply circuit.

In Example 29, the subject matter of Example 28 optionally includes wherein the valve manifold comprises: a cold bypass three-way valve fluidly connected to the cold fluid supply circuit and selectively fluidly connected to the first cold fluid three-way valve and the cold fluid supply circuit; and a hot bypass three-way valve fluidly connected to the hot fluid supply circuit and selectively fluidly connected to the first hot fluid three-way valve and the hot fluid supply circuit.

In Example 30, the subject matter of Example 29 optionally includes wherein the control system is configured to operate the valve manifold in a switching mode, and wherein: in the switching mode, the control system fluidly connects the cold bypass three-way valve to the cold fluid supply circuit to bypass the first cold fluid three-way valve; and in the switching mode, the control system fluidly connects the hot bypass three-way valve and the hot fluid supply circuit to bypass the first hot fluid three-way valve.

In Example 31, the subject matter of any one or more of Examples 21-30 optionally include wherein the heat exchanger includes a shell and tube heat exchanger, a tube side of the shell and tube heat exchanger is connected to the thermal shock circuit, and a shell side of the shell and tube heat exchanger is connected to the hot fluid supply circuit and the cold fluid supply circuit.

In Example 32, the subject matter of any one or more of Examples 21-31 optionally include wherein the thermal shock circuit further comprises: a pump configured to pump a fluid through the thermal shock circuit; a flow meter configured to detect a flow rate of the fluid flowing through the thermal shock circuit; a pressure sensor configured to detect a pressure within the thermal shock circuit; and a thermal sensor configured to detect the temperature within the thermal shock circuit.

In Example 33, the subject matter of Example 32 optionally includes wherein the thermal shock circuit comprises: a control system configured to independently control the flow rate of fluid flow through the thermal shock circuit to adjust the temperature and the pressure within the thermal shock circuit based on feedback from one or more of the pump, the flow meter, the pressure sensor, or the thermal sensor.

In Example 34, the subject matter of Example 33 optionally includes wherein the control system is configured to perform a calibration cycle to control the thermal shock circuit to a specified flow rate, a specified pressure, and a specified temperature, and wherein, in the calibration cycle, the control system is configured to: transmit a start pump signal to the pump to set the pump to a known pumping rate; generate, based on comparing one or more of the specified flow rate and the flow rate of the fluid flowing through the thermal shock circuit, the specified temperature and the temperature, or the specified pressure and the pressure, a delta value; determine, based on the delta value, an updated pumping rate; and transmitting, based on the updated pumping rate, a power control signal to set the pump to the updated pumping rate.

Example 35 is a thermal shock system for testing two or more components simultaneously in different chambers, comprising: a cold fluid supply circuit to deliver a cold fluid; a hot fluid supply circuit to deliver a hot fluid; a plurality of test chambers, each test chamber of the plurality of test chambers including a heat exchanger with a primary side and a secondary side; a fluid distribution network configured to selectively route the cold fluid and the hot fluid to the primary side of the heat exchangers; a plurality of device under test circuits; each device under test circuit of the plurality of device under test circuits connected to the secondary side of the heat exchanger and configured to circulate fluid to a component within the respective test chamber of the plurality of test chambers; and a control system configured to: control the fluid distribution network to alternatively expose the plurality of device under test circuits to the cold fluid and the hot fluid via the heat exchangers; and independently control fluid flow in each device under test circuit of the plurality of device under test circuits.

In Example 36, the subject matter of Example 35 optionally includes wherein the plurality of test chambers comprises: a first group of test chambers; and a second group of test chambers, and wherein the control system is configured to alternatively expose the first group of test chambers to one of the hot fluid or the cold fluid and the second group of test chambers to the other of the hot fluid or the cold fluid.

In Example 37, the subject matter of Example 36 optionally includes wherein the fluid distribution network is operable between a first mode, a second mode, and a switching mode; wherein: in the first mode, the fluid distribution network directs the hot fluid to the first group of test chambers and the cold fluid to the second group of test chambers; in the second mode, the fluid distribution network directs the cold fluid to the first group of test chambers and the hot fluid to the second group of test chambers; and in the switching mode, the fluid distribution network directs the cold fluid supply circuit back to a cold fluid source and the hot fluid supply circuit back to a hot fluid source to prevent the cold fluid and the hot fluid from flowing through the fluid distribution network.

In Example 38, the subject matter of any one or more of Examples 35-37 optionally include wherein each device under test circuit comprises: a pump; a flow meter to generate a flow signal indicative of a detected flow of fluid in each respective device under test circuit; a pressure sensor to generate a pressure signal indicative of a detected pressure within each respective device under test circuit; and a temperature sensor to generate a temperature signal indicative of a detected pressure within each respective device under test circuit; wherein the control system is configured to receive the flow signal, the pressure signal, and the temperature signal and control fluid flow through each respective device under test circuit independently from other device under test circuits of the plurality of device under test circuits, and wherein the control system is configured to perform an air purge routine for each device under test circuit by cycling the pump of each device under test circuit between a maximum speed and a minimum speed to remove air from the thermal shock system.

Example 39 is a method of operating a thermal shock system, comprising: directing a cold fluid from a cold fluid supply circuit and a hot fluid from a hot fluid supply circuit to a valve manifold; and alternately directing, via the valve manifold: the hot fluid to a first thermal shock circuit to expose a first component to a first temperature; and the cold fluid to the first thermal shock circuit to expose the first component to a second temperature.

In Example 40, the subject matter of Example 39 optionally includes wherein the valve manifold is fluidly coupled to a second thermal shock circuit, the method further comprising: alternately directing, via the valve manifold: the hot fluid to the second thermal shock circuit to expose a second component to a third temperature; and the cold fluid to the second thermal shock circuit to expose the second component to a fourth temperature; and wherein the first temperature and the third temperature are higher than the second temperature and the fourth temperature, respectively.

Example 41 includes a method, apparatus, system, or computer-readable medium including any element of any of Examples 1-40.

The above-detailed description includes references to the accompanying drawings, which form a part of the detailed description. The drawings show, by way of illustration, specific examples that can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The above description is intended to be illustrative, and not restrictive. For example, the above-described examples (or one or more aspects thereof) can be used in combination with each other. Other examples can be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. A thermal shock system for testing components, the thermal shock system comprising:
a cold fluid supply circuit configured to deliver a cold fluid;
a hot fluid supply circuit configured to deliver a hot fluid;
a heat exchanger fluidly connected to the cold fluid supply circuit, the hot fluid supply circuit;
a valve manifold fluidly coupled to the cold fluid supply circuit and the hot fluid supply circuit; and
a thermal shock circuit coupled to the valve manifold, wherein:
the thermal shock circuit is configured to receive a component for thermal shock testing;
the thermal shock circuit includes a tertiary fluid that is selectively thermally coupled, via the heat exchanger, to the cold fluid or the hot fluid based at least in part on a configuration of the valve manifold;
the thermal shock circuit is configured to expose the component to a temperature based at least in part on the valve manifold being in a configuration to thermally couple the tertiary fluid with the cold fluid; and
the thermal shock circuit is configured to expose the component to a second temperature based at least in part on the valve manifold being in a second configuration to thermally couple the tertiary fluid with the hot fluid.

2. The thermal shock system of claim 1, further comprising:
a plurality of test chambers, each test chamber of the plurality of test chambers including a heat exchanger with a primary side and a secondary side;
a fluid distribution network configured to selectively route the cold fluid and the hot fluid to the primary side of the heat exchangers, the fluid distribution network including a valve manifold selectively fluidly connected to the cold fluid supply or the hot fluid supply and fluidly connected to each heat exchanger of the plurality of test chambers;
a plurality of device under test circuits; each device under test circuit of the plurality of device under test circuits connected to the secondary side of the heat exchanger and configured to circulate a tertiary fluid to a component within the respective test chamber of the plurality of test chambers; and
a control system configured to:
control the fluid distribution network to alternatively expose the plurality of device under test circuits to the cold fluid and the hot fluid via the heat exchangers; and
independently control flow of the tertiary fluid in each device under test circuit of the plurality of device under test circuits.

3. The thermal shock system of claim 1, wherein the thermal shock system further compriess:
a second thermal shock circuit including:
a second chamber configured to receive a second component for thermal shock testing; and
a second heat exchanger fluidly connected to the cold fluid supply circuit, the hot fluid supply circuit, and the second thermal shock circuit, the second heat exchanger configured to transfer thermal energy from the cold fluid and the hot fluid to the second thermal shock circuit.

4. The thermal shock system of claim 3, wherein the second heat exchanger includes a shell and tube heat exchanger, a tube side of the shell and tube heat exchanger is connected to the second thermal shock circuit, and a shell side of the shell and tube heat exchanger is connected to the hot fluid supply circuit and the cold fluid supply circuit.

5. The thermal shock system of claim 3, wherein the second thermal shock circuit comprises:
a pump configured to pump a fluid through the second thermal shock circuit;
a flow meter configured to detect a flow rate of the fluid flowing through the second thermal shock circuit;
a pressure sensor configured to detect a second pressure within the second thermal shock circuit; and
a thermal sensor configured to detect a second temperature within the second thermal shock circuit.

6. The thermal shock system of claim 5, wherein the second thermal shock circuit comprises:
a control system configured to independently control the flow rate of fluid flow through the second thermal shock circuit to adjust the second temperature and the second pressure within the second thermal shock circuit based on feedback from one or more of the pump, the flow meter, the pressure sensor, or the thermal sensor.

7. The thermal shock system of claim 3, wherein the valve manifold comprises:
a first cold fluid three-way valve fluidly connected to the cold fluid supply circuit and selectively fluidly connected to the heat exchanger and the second heat exchanger;
a first hot fluid three-way valve fluidly connected to the hot fluid supply circuit and selectively fluidly connected to the heat exchanger and the second heat exchanger;
a first return three-way valve fluidly connected to an outlet of the heat exchanger and selectively fluidly connected to the cold fluid supply circuit and the hot fluid supply circuit; and
a second return three-way valve fluidly connected to an outlet of the second heat exchanger and selectively fluidly connected to the cold fluid supply circuit and the hot fluid supply circuit.

8. The thermal shock system of claim 7, comprising:
a control system configured to operate the valve manifold between a first mode and a second mode, wherein:
in the first mode, the control system fluidly connects the first hot fluid three-way valve and the heat exchanger to direct the hot fluid toward the heat exchanger;
in the first mode, the control system fluidly connects the first return three-way valve and the hot fluid supply circuit to fluidly connect the heat exchanger and the hot fluid supply circuit;
in the first mode, the control system fluidly connects the first cold fluid three-way valve and the second heat exchanger to direct the cold fluid toward the second heat exchanger;
in the first mode, the control system fluidly connects the second return three-way valve and the cold fluid supply circuit to fluidly connect the second heat exchanger and the cold fluid supply circuit;
in the second mode, the control system fluidly connects the first hot fluid three-way valve and the second heat exchanger to direct the hot fluid toward the second heat exchanger;
in the second mode, the control system fluidly connects the second return three-way valve to the hot fluid supply circuit to fluidly connect the second heat exchanger and the hot fluid supply circuit;
in the second mode, the control system fluidly connects the first cold fluid three-way valve and the heat exchanger to direct the cold fluid toward the heat exchanger; and
in the second mode, the control system fluidly connects the first return three-way valve and the cold fluid supply circuit to fluidly connect the heat exchanger and the cold fluid supply circuit.

9. The thermal shock system of claim 8, wherein the valve manifold comprises:
a cold bypass three-way valve fluidly connected to the cold fluid supply circuit and selectively fluidly connected to the first cold fluid three-way valve and the cold fluid supply circuit; and
a hot bypass three-way valve fluidly connected to the hot fluid supply circuit and selectively fluidly connected to the first hot fluid three-way valve and the hot fluid supply circuit.

10. The thermal shock system of claim 9, wherein the control system is configured to operate the valve manifold in a switching mode, and wherein:
in the switching mode, the control system fluidly connects the cold bypass three-way valve to the cold fluid supply circuit to bypass the first cold fluid three-way valve; and
in the switching mode, the control system fluidly connects the hot bypass three-way valve and the hot fluid supply circuit to bypass the first hot fluid three-way valve.

11. The thermal shock system of claim 1, wherein the heat exchanger includes a shell and tube heat exchanger, a tube side of the shell and tube heat exchanger is connected to the thermal shock circuit, and a shell side of the shell and tube heat exchanger is connected to the hot fluid supply circuit and the cold fluid supply circuit.

12. The thermal shock system of claim 1, wherein the thermal shock circuit further comprises:
a pump configured to pump a fluid through the thermal shock circuit;
a flow meter configured to detect a flow rate of the fluid flowing through the thermal shock circuit;
a pressure sensor configured to detect a pressure within the thermal shock circuit; and
a thermal sensor configured to detect the temperature within the thermal shock circuit.

13. The thermal shock system of claim 12, wherein the thermal shock circuit comprises:
a control system configured to independently control the flow rate of fluid flow through the thermal shock circuit to adjust the temperature and the pressure within the thermal shock circuit based on feedback from one or more of the pump, the flow meter, the pressure sensor, or the thermal sensor.

14. The thermal shock system of claim 13, wherein the control system is configured to perform a calibration cycle to control the thermal shock circuit to a specified flow rate, a specified pressure, and a specified temperature, and wherein, in the calibration cycle, the control system is configured to:
transmit a start pump signal to the pump to set the pump to a known pumping rate;
generate, based on comparing one or more of the specified flow rate and the flow rate of the fluid flowing through the thermal shock circuit, the specified temperature and the temperature, or the specified pressure and the pressure, a delta value;
determine, based on the delta value, an updated pumping rate; and
transmitting, based on the updated pumping rate, a power control signal to set the pump to the updated pumping rate.

15. A thermal shock system for testing two or more components simultaneously in different chambers, comprising:
a cold fluid supply circuit to deliver a cold fluid;
a hot fluid supply circuit to deliver a hot fluid;
a plurality of test chambers, each test chamber of the plurality of test chambers including a heat exchanger with a primary side and a secondary side;
a fluid distribution network configured to selectively route the cold fluid and the hot fluid to the primary side of the heat exchangers;
a plurality of device under test circuits; each device under test circuit of the plurality of device under test circuits connected to the secondary side of the heat exchanger and configured to circulate a tertiary fluid to a component within the respective test chamber of the plurality of test chambers; and
a control system configured to:
control the fluid distribution network to alternatively expose the plurality of device under test circuits to the cold fluid and the hot fluid via the heat exchangers; and
independently control flow of the tertiary fluid in each device under test circuit of the plurality of device under test circuits.

16. The thermal shock system of claim 15, wherein the plurality of test chambers comprises:
a first group of test chambers; and
a second group of test chambers, and wherein the control system is configured to alternatively expose the first group of test chambers to one of the hot fluid or the cold fluid and the second group of test chambers to the other of the hot fluid or the cold fluid.

17. The thermal shock system of claim 16, wherein the fluid distribution network is operable between a first mode, a second mode, and a switching mode;
wherein:
in the first mode, the fluid distribution network directs the hot fluid to the first group of test chambers and the cold fluid to the second group of test chambers;
in the second mode, the fluid distribution network directs the cold fluid to the first group of test chambers and the hot fluid to the second group of test chambers; and
in the switching mode, the fluid distribution network directs the cold fluid supply circuit back to a cold fluid source and the hot fluid supply circuit back to a hot fluid source to prevent the cold fluid and the hot fluid from flowing through the fluid distribution network.

18. The thermal shock system of claim 15, wherein each device under test circuit comprises:
a pump;
a flow meter to generate a flow signal indicative of a detected flow of fluid in each respective device under test circuit;
a pressure sensor to generate a pressure signal indicative of a detected pressure within each respective device under test circuit; and
a temperature sensor to generate a temperature signal indicative of a detected pressure within each respective device under test circuit;
wherein the control system is configured to receive the flow signal, the pressure signal, and the temperature signal and control fluid flow through each respective device under test circuit independently from other device under test circuits of the plurality of device under test circuits, and wherein the control system is configured to perform an air purge routine for each device under test circuit by cycling the pump of each device under test circuit between a maximum speed and a minimum speed to remove air from the thermal shock system.

19. A method of operating a thermal shock system, comprising:
directing a cold fluid from a cold fluid supply circuit and a hot fluid from a hot fluid supply circuit to a valve manifold; and
alternately directing, via the valve manifold:
the hot fluid to a first thermal shock circuit to fluidly couple the hot fluid to a tertiary fluid of the first thermal shock circuit to expose a first component to a first temperature; and
the cold fluid to the first thermal shock circuit to fluidly couple the cold fluid to the tertiary fluid of the first thermal shock circuit to expose the first component to a second temperature.

20. The method of claim 19, wherein the valve manifold is fluidly coupled to a second thermal shock circuit including a second tertiary fluid, the method further comprising:
alternately directing, via the valve manifold:
the hot fluid to the second thermal shock circuit to fluidly couple the hot fluid and the second tertiary fluid to expose a second component to a third temperature; and
the cold fluid to the second thermal shock circuit to fluidly couple the cold fluid and the second tertiary fluid to expose the second component to a fourth temperature; and
wherein the first temperature and the third temperature are higher than the second temperature and the fourth temperature, respectively.
